(19) United States
(12) Patent Application Publication
(10) Pub. No.: US 2005/0181928 A1
(43) Pub. Date: Aug. 18, 2005

(54) Reaction-bonded porous magnesia body

(76) Inventors: Peter J. Hayward, Pinawa (CA); Richard Higgins, Reading, MA (US); Robert L. Goldsmith, Wayland, MA (US); Bruce A. Bishop, Arlington, MA (US)

Correspondence Address: BRIAN M. DINGMAN;MIRICK, O'CONNELL, DEMALLIE & LOUGEE, LLP, 100 FRONT STREET, WORCESTER, MA, 01608, US

(21) Appl. No.: 10/777,231

(22) Filed: Feb. 12, 2004

(51) Int. Cl. C04B 35/03

(52) U.S. Cl. 501/108; 501/122; 501/120

(57) ABSTRACT

A porous reaction-bonded magnesia body with small or negligible shrinkage between the green state and the fired state. The body made by forming a green (i.e., unfired) body of mixed powders containing coarse grains of magnesia in combination with at least one reactive element, and optionally other ceramic oxides and/or compounds, followed by sintering in an oxidizing atmosphere. During sintering, oxidation and/or reaction of the element grain results in an overall volume change that is negligibly small or zero. The resulting body is highly porous, and may be used as a support for a semi-permeable membrane, especially relatively high coefficient of thermal expansion, high-temperature gas separation membranes.

### FIELD OF THE INVENTION

This invention relates to a porous reaction-bonded magnesia body that exhibits small or negligible shrinkage between the green state and the fired state. The body is made by the forming a green (i.e., unfired) body of mixed powders containing coarse grains of magnesia in combination with at least one reactive element, and optionally other ceramic oxides and/or compounds, followed by sintering in an oxidizing atmosphere. The body is useful as a membrane support, especially for relatively high coefficient of thermal expansion, high-temperature gas separation membranes.

### BACKGROUND OF INVENTION

Magnesium oxide (magnesia) is infrequently used as a structural ceramic. Relative to other oxide ceramics, such as alumina, it has relatively poor chemical durability and strength, and is difficult to sinter. However, magnesia has a useful property in its high coefficient of thermal expansion (CTE) of about 13.5×10⁻⁶/° C., between 0 and 1,000° C. (“Introduction to Ceramics”, 2^{nd} Edition, W. D. Kingery, et al., John Wiley, 1976, page 595). This high CTE is especially attractive for a porous structure for use as a support for an inorganic membrane with a comparable CTE. Magnesia is the only substantially pure phase refractory ceramic with such a high CTE.

Inorganic gas separation membranes generally may be classed into three categories: dense metallic membranes, dense ion transport oxide membranes, and microporous silica and zeolite membranes. Included in the category of metallic membranes are palladium, palladium-copper and palladium-silver alloys for hydrogen separations. For ion transport membranes, mixed conducting oxides are useful for separations of oxygen or hydrogen (the permeable species) from gas mixtures. For microporous oxide membranes, silica and a wide range of zeolite structures have been developed.

Several of these membrane materials have a relatively high CTE. Deposition of these membranes as a thin film onto a microporous support structure requires a reasonably close match between the CTE of the support and the CTE of the membrane layer. Table 1 provides ranges of CTE's for most classes of inorganic gas separation membranes. The membranes relevant for the present invention are those that can be classed as metallic membranes and dense ion transport membranes, which have CTE's in excess of about 10×10⁻⁶/C.

TABLE 1
Coefficients of Thermal Expansion of Gas Separation Membranes

| Membrane Material | CTE, × 10⁶/° C. |
|---|---|
| Palladium and palladium alloys | 12 to 16 |
| Dense oxide ion transport | 9 to 20 |
| Microporous silica | 1 to 3 |
| Zeolites | −1 to 6 |

These membranes are typically coated onto porous supports in at least four configurations: planar, tubular, hollow fiber, and multi-channel monolith. Support materials can be porous ceramic or porous metal, of a variety of compositions.

The subject of the present invention is a ceramic oxide with a relatively high CTE that is useful as a membrane support. The material (magnesia) is of special interest because of its relative chemical inertness, ease of fabrication into various shapes, thermal stability, and relatively low cost. The novelty of the present invention lies in the means of producing such magnesia porous bodies, which is achieved through a “reaction-bonding” mechanism. Reaction bonding is described in co-pending applications of the present Assignee, incorporated herein by reference, (U.S. patent application Ser. Nos. 10/097,921 and 10/685,057). In brief, reaction bonding of magnesia grains is achieved when at least one other solid phase granular material reacts with a gas, liquid or solid to form a separate compound that is the bonding agent for the magnesia grains. A further aspect of the reaction bonding is that it is possible for the reaction to result in a volumetric expansion of the bonding phase to minimize shrinkage of the body during the sintering/bonding process.

Deposition and use of the high-CTE membranes under conditions of temperature cycling requires use of support materials with similarly high CTE values. Porous α-alumina (CTE of ˜8.2×10⁻⁶/° C.) is at the lower CTE limit for a useful porous support material for palladium (and other metallic) membranes, as well as for low-CTE dense ITM membranes. As is known in the art, for ITM membranes, often the membrane support is comprised of the same material as the membrane itself. However, this often provides an expensive support, one that can have poor mechanical strength, and may exhibit creep at elevated temperatures.

Supports for the above gas separation membranes have included primarily tubular elements and stacked plate devices. The present invention is suitable for these support configurations, but is especially well suited for multi-channel honeycomb monolith supports. These are described in the above-referenced U.S. patent application Ser. Nos. 10/097,921 and 10/685,057. These high surface area, compact support structures are especially attractive for the production of practical membrane devices.

This invention has as a central feature the use of high-CTE, reaction-bonded magnesia as a membrane support, the material exhibiting nil or very low (<5% linear) shrinkage during the sintering of the green support structure. This invention is similar to the use of RBAO as a membrane support, which is reviewed in U.S. patent application Ser. No. 10/097,921.

Alternative High CTE Ceramics for Membrane Supports. There are only a few oxide ceramics with relatively high CTEs that can be considered in reaction-bonded forms for practical, cost-effective production of monolith substrates. Additionally, there is the possibility of using high CTE ceramic compounds for monolith fabrication. These compounds include, but are not restricted to, magnesium orthosilicate (forsterite, Mg₂SiO₄) and magnesium aluminate (spinel, MgAlO₂), which have mean 0-1,000° C. CTE values of 10.5×10⁻⁶/° C. and ˜8.5×10⁻⁶/° C., respectively. The present invention is based on the use of porous magnesia supports, and employs a reaction-bonding mechanism using elemental precursors during firing of the formed green support. Preferred reaction products that form the bonding phase are forsterite and spinel.

There is little published literature on the use of porous magnesia as membrane supports. Air Products and Chemicals, Inc. has described the use of porous tubular pure magnesia supports for ion transport membranes (U.S. Pat. Nos. 5,332,597; 5,360,635; and 5,683,797), but no suggestion is made for the use of reaction-bonded magnesia. Other research groups have reported on the use of porous pure magnesia disk membrane supports (for example, Liang Hong, et al., “Preparation of a perovskite La_{0.2}Sr_{0.8}CoO₃₋ₓ membrane on a porous MgO substrate”, in the Journal of the European Ceramic Society 21 (2001) 2207-2215; and Hugh Middleton, et al., “Co-casting and co-sintering of porous MgO support plates with thin dense perovskite layers of LaSrFeCoO₃”, in the Journal of the European Ceramic Society 24 (2004) 1083-1086). In general, the patent and technical literature on the use of magnesia as a membrane support is limited, because of the difficulty of fabrication of pure porous magnesia supports with high strength.

### SUMMARY OF INVENTION

It is therefore an object of this invention to provide a reaction-bonded, high-CTE porous magnesia body.

It is a further object of this invention to provide such a magnesia body that is suitable as a support for gas separation membranes with closely matching coefficients of thermal expansion.

It is a further object to provide such a magnesia body that exhibits small to negligible volume change on sintering.

It is a further object of this invention to provide such a body that has a mean pore size and porosity required to effectively serve as a support for a pressure driven membrane device.

This invention results from the realization that the fabrication of such a body is most readily achieved using a green body (unfired body) composition that undergoes minimal volume change on sintering, and that this can be accomplished by forming a green body containing at least one element that undergoes a volumetric expansion upon oxidation or reaction, together with relatively coarse magnesia grains mixed in a proportion such that the overall volume change during sintering is controllably small.

This invention also results from the realization that certain minimum porosity and permeability properties of the membrane support are required for composite membrane devices. Finally, this invention also realizes that incorporating a magnesia powder with a particle size distribution above a certain minimum size range is needed to produce the minimum pore size and permeability requirements for the effective use of such bodies as membrane supports.

This invention features a porous reaction-bonded magnesia body. In one embodiment, the body has a porosity greater than about 30%, and in another embodiment, the body has a mean pore size greater than about 1 micron.

In yet another embodiment, the porous body can serve as a membrane support for a permselective membrane. The membrane device can be used for gas separations, and the membrane can be selected from the group comprising dense metallic and ion transport membranes. The structure of the porous body can be in a tubular, planar, hollow fiber, or multiple passageway monolith configuration.

This invention also features a porous reaction-bonded magnesia body formed by sintering a green body containing coarse magnesia grains and reactive grains of an inorganic binder precursor. In one embodiment, the reaction bond is formed from the reaction of grains of an element admixed with the coarse magnesia grains. The magnesia grains can have a mean particle size in the range of about 5 to 200 microns, and the element can be selected from the group comprising aluminum, silicon, titanium, zirconium, and mixtures thereof.

In yet another embodiment, the green body can contain silicon grains and the reaction bond is forsterite. Alternatively, the green body can contain aluminum grains and the reaction bond is spinel. Preferably, the volume change of the sintered porous body from the unsintered green body is less than about five percent.

This invention also features a method for making a porous reaction-bonded magnesia body, which includes making a mixture containing at least coarse magnesia grains and grains of an inorganic reactive binder precursor, forming the mixture into a desired shape and drying to obtain a green body, firing the green body to a temperature sufficient to react the inorganic reactive binder precursor, and cooling the reaction-bonded body.

### BRIEF DESCRIPTION OF THE DRAWINGS

FIG. 1 is a thermogravimetric analysis (TGA) of the reaction bonding of a zirconia bonded magnesia body, Sample RBZM-2 of EXAMPLE 1.

FIG. 2 is an X-ray diffraction (XRD) analysis of a reaction bonded zirconia magnesia body, Sample RBZM-1 of EXAMPLE 1.

FIG. 3 contains a thermogravimetric analysis/differential thermogravimetric analysis (TGA/DTA) of a fosterite bonded magnesia body, Example MS-6 in EXAMPLE 3.

FIG. 4 is an XRD analysis of a fosterite reaction bonded body corresponding to the data of FIG. 3.

FIG. 5 is an XRD analysis of another fosterite reaction bonded body containing a small amount of titania sintering aid, Sample MS-8 in EXAMPLE 3.

FIG. 6 is a DTA/TGA analysis of a spinel bonded magnesia body, Sample MA-1 in EXAMPLE 4.

FIG. 7 is an XRD analysis of a spinel bonded magnesia body, Sample MA-2 in EXAMPLE 4.

### DETAILED DESCRIPTION OF THE INVENTION

The present invention relates to the production of strong, high-CTE, porous, reaction-bonded magnesia bodies that can be formed with small to negligible volume change during sintering. Such materials can be used, for example, as membrane supports in membrane devices for elevated-temperature gas separations. The use of such high-CTE supports enables matching, within certain limits, of the CTEs of the support and the deposited gas separation membrane.

The porous membrane support can be fabricated in several configurations, including tubular elements, plates for a plate and frame configuration, hollow fibers, and monoliths that contain a plurality of passageways that extend from a feed inlet end face to a retentate outlet end face, all of which are well known in the art.

The basis for the invention involves fabrication of a precursor (“green”) ceramic substrate by extrusion, or by other means, of a mixture containing a relatively coarse, high-CTE magnesia powder and a fine powder fraction of one or more elements. As a further option, the fine powder fraction may include additional ceramic oxides or compounds and other chemicals as a co-reactant or a means of controlling the dimensional changes, strength, porosity and permeability of the ceramic substrate after firing. Also, appropriate organic binders and plasticizers may be included in the batch formulation to assist fabrication and/or to give improvements in the final ceramic properties. For green bodies containing such mixtures, the shrinkage that accompanies sintering to form the final ceramic device is counteracted by expansion that occurs from oxidation or reaction of the element grains. In the current invention, however, the overall porosity is largely defined by the initial packing of the coarse magnesia particles, which are chosen to undergo small volume change during sintering. The strength of the sintered body is derived from the creation of “necks” between the coarse and fine particles during element oxidation/reaction and sintering. Neck formation produces a minimal reduction in the pore density during sintering, so that a relatively small amount of elemental grain may be sufficient to compensate for volume change.

The coarse magnesia grain material preferably has a narrow particle size distribution so that the porosity of the final monolith is maximized. The typical particle size of a preferred magnesia grain is in the range of about 5 to 200 μm. This size of grain will result in a desirable mean pore size range of about 1 to 50 μm.

With regard to the reaction-bonding element, several characteristics are desirable. If the reaction product is a ceramic oxide, an important requirement is that the element should have a Pilling-Bedworth ratio (P-B ratio) greater than one. The P-B ratio relates to the volume expansion of an element (usually a metal) during oxidation, typically as the result of heating in an oxygen-containing atmosphere; it is defined as the ratio of the molar volume of the resulting metal oxide to that of the precursor metal prior to oxidation. Thus, a P-B ratio >1.0 indicates that the metal undergoes a volumetric expansion during oxidation.

A second requirement is that the reaction product should exhibit thermal stability (i.e., not undergo any disruptive reactions or phase changes) at all temperatures below the sintering temperature. Additionally, the oxide reaction product should be able to bond to the coarse ceramic grains in the body during high temperature sintering, thereby imparting adequate strength to the fired body. Furthermore, the reaction product should have a relatively high CTE and low CTE anisotropy to minimize CTE mismatch of the component phases in the sintered body. In some cases, it may be desirable that the elemental powder melts and wets the coarse ceramic grains prior to oxidation. Finally, the element should be safe for a manufacturing process and have an acceptable cost.

Elements that can satisfy these requirements include aluminum, silicon, titanium, zirconium, and mixtures thereof. Preferably, the particle size of the element grain is smaller than that of the coarse ceramic grain, typically with a mean particle size of <1 micron up to 10 microns. Some properties of the preferred elements are summarized in Table 2.

As indicated in Table 2, the high-temperature oxidation of Si to produce β-cristobalite, the thermodynamically stable SiO₂ phase above 1470° C., is an undesirable product during sintering of a reaction-bonded substrate because β-cristobalite typically persists as a metastable phase during subsequent cooling, and undergoes a displacive transition to α-cristobalite at ˜270° C., accompanied by a large volume change that would cause fracture of the substrate. An important property of Si during high temperature oxidation, however, is that the resulting oxide can undergo a near-simultaneous reaction with other oxides to form high CTE compounds with a concomitant increase in volume. An example of this phenomenon is the near-simultaneous reaction of oxidized Si with MgO to form forsterite. Thus, if there is sufficient MgO available, the reaction leaves no free silica (cristobalite, etc.) in the fired body.

TABLE 2
Properties of Elements for Use in Reaction-Bonded Monoliths

| Element | P-B Ratio | Oxide CTE, × 10⁶/° C. |
|---|---|---|
| Aluminum | 1.29 | 8.2 |
| Titanium | 1.56 | 8.8 |
| Zirconium | 1.76 | 10 |
| Silicon: Si oxidizes to | 1.88-2.15 | Undergoes displacive |
| α-quartz at temperatures | (depending on | β/α transitions during |
| up to 573° C., to | SiO₂ | cooling, notably β/α |
| β-quartz at 573-870° C., | polymorph | cristobalite transition |
| or to tridymite at 870-1470° C. | formed) | at ˜270° C. |
| Above 1470° C., Si oxidizes to | | |
| β-cristobalite. Metastable | | |
| cristobalite usually persists | | |
| during cooling. | | |

Similarly, Al metal can also undergo oxidation and near-simultaneous reaction with other oxides to form high CTE compounds, such as the reaction with MgO to produce spinel, which is also accompanied by a volume increase. The volume changes associated with these reactions can be used to minimize or eliminate high temperature shrinkage from sintering, and are summarized in Table 3.

Additional ceramic oxides and compounds can also be included in the mixture of coarse ceramic and fine elemental grains to impart desired structural or chemical properties. These possible additions include fine alumina, zirconia, titania, magnesia, ceria and mixtures thereof, with grain sizes in the approximate range of 10 nm to 1 μm. Such additions can give enhanced bonding strength and improved permeability during sintering by participating in the reaction-bonding mechanism, or by causing changes in the sintering mechanism and in the resulting ceramic microstructure.

TABLE 3
Volume Changes from Oxidation and Near-Simultaneous Reaction
To form High-CTE Compounds

| | Volume | |
|---|---|---|
| Oxidation/Reaction | Change | Product, CTE |
| Si + O₂ + 2MgO → Mg₂SiO₄ | 29.6% | Forsterite, ˜10.5 × 10⁶/ |
| | expansion | ° C. |
| 4Al + 3O₂ + 2MgO → 2MgAl₂O₄ | 26.5% | Spinel, ˜9 × 10⁶/° C. |
| | expansion | |

Additionally, small amounts of other chemicals may be added to assist high temperature sintering. These sintering aids include compatible materials that will form liquid phases at the sintering temperature, thereby accelerating the rate of material transfer between the solid ceramic grains to form necks. For magnesia, of special interest as a high CTE oxide, small amounts (<1 wt %, preferably <0.5 wt %) of LiF (m.pt. 870° C. m pt., 1676,° C. b.pt.), MgCl₂ (m.pt. 708° C., b.pt 1412° C.), or MgF₂ (m.pt. 1266° C., b.pt >2200° C.) can be used to promote sintering. The F⁻ ion has an almost identical ionic radius to the O⁻ ion, and F readily dissolves in most oxide structures up to a few wt. %, so that the effect on MgO properties is minimal. The use of MgCl₂ as a sintering aid is described in K. Hamano, Z. Nakagawa, and H. Watanabe, “Effect of Magnesium Chloride on Sintering of Magnesia,” in Advances in Ceramics, Vol. 10, Structure and Properties of MgO and Al₂O₃ Ceramics, ed. W. D. Kingery, (The American Ceramic Society: Columbus, 1984) p. 610.

Further, to increase porosity of the body, fugitive pore formers can be incorporated in to the green body. These can include, graphite, carbon powder, carbon black, starch, or any other granular material that is fugitive during the sintering process, generally by oxidation. The use of pore formers is well known in the art and widely employed in the commercial production of extruded ceramic bodies, including monoliths and porous substrates.

A variety of organic additives can be employed as lubricants to facilitate extrusion, including stearic acid, wax emulsions, etc. Organic binders are also employed to impart strength to the extrudates and to facilitate handling of the green body. Typical organic binders include methylcellulose, carboxymethylcellulose, polyvinyl alcohols, polyvinyl pyrrolidone, and naturally occurring sugars, starches and gums. The use of lubricants and organic binders is well known in the art and widely employed in the commercial production of extruded ceramic bodies, including monoliths and porous substrates.

### EXAMPLE 1

Pressed pellets containing zirconium, zirconia, and magnesia grains were fired in air to produce zirconia-bonded magnesia pellets (RBZM), which were characterized by various means. Table 4 shows the batch compositions of three formulations examined, using progressively increasing Zr metal contents.

Mixing, Pressing and Firing Procedures: In all cases, the inorganic powders were briefly milled with dry alumina media to break up agglomerates. After removal of the media and blending in of the methylcellulose powder, the solids were thoroughly mixed with a solution of stearic acid in warm ethanol. Finally, a mixed solution of the ethylene glycol, PVA solution and pure water components was added and blended in. The batch was then sealed in polyethylene and stored overnight to allow hydration of the methylcellulose powder.

A series of eight ˜4-g pellets of each mix were pressed between 2.5-cm filter paper disks (to prevent sticking) in a 1.0-inch diameter hardened steel die at a pressure of ˜2800 psi. The pellets were then dried at 100° C. for 1-2 hours in a forced air convection oven.

TABLE 4
Batch Compositions Used for Firing Trials

| Component | RBZM-1 | RBZM-2 | RBZM-3 |
|---|---|---|---|
| Coarse magnesia (Cerac M-1138, | 47.3 g | 48.3 g | 49.3 g |
| 95% pure, −140 mesh +325 mesh) | | | |
| Yttria-stabilized ZrO₂ (Magnesium | 22.3 g | 17.0 g | 11.6 g |
| Elektron Inc., type 5Y, 0.6 μm, 8% | | | |
| Y₂O₃) | | | |
| Zr metal powder (Alfa Aesar, stock # | 8.0 g | 12.3 g | 16.7 g |
| 00847, 95+% purity, 2-3 μm) | | | |
| Tylose MH300 methyl cellulose | 4.2 g | 4.2 g | 4.2 g |
| Elvanol grade 85-82 polyvinyl | 1.1 g | 1.1 g | 1.1 g |
| alcohol (PVA), 7 wt. % solution in | | | |
| water | | | |
| Stearic acid | 1.1 g | 1.1 g | 1.1 g |
| Ethylene glycol | 0.4 g | 0.4 g | 0.4 g |
| Ethanol | 4.0 g | 4.0 g | 4.0 g |
| Water. | 7.7 g | 7.7 g | 7.7 g |

Two furnaces were used for pellet firing: a programmable silicon carbide (Carbolite) muffle furnace for precise control of heating rates at lower temperatures, and a programmable molybdenum disilicide (CM) box furnace for sintering at higher temperatures (≧1500° C.). The firing schedules were as follows:
Carbolite furnace: The pellets were fired to 800° C. at 1° C./min, and then from 800 to 1400° C. at 4° C./min, followed by immediate cooling to room temperature at 10° C./min. The pellets were then transferred to the CM furnace.
CM furnace: The pellets were re-fired to 1500° C. at 10° C./min, holding for 2 hours at 1500±10° C. before cooling to room temperature at 10° C./min.

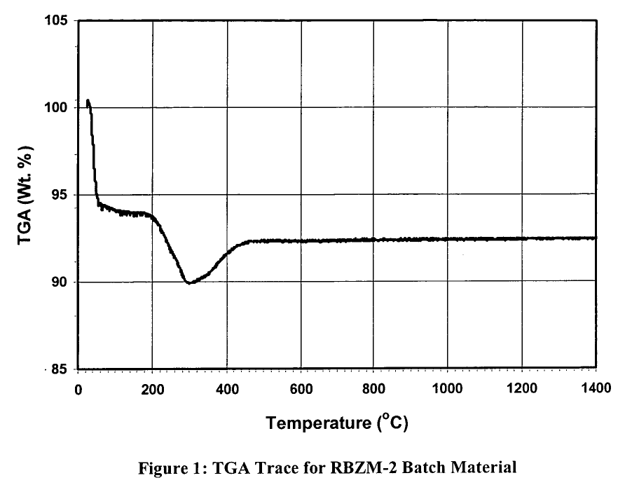

Simultaneous differential thermal analysis/thermogravimetric analysis (DTA/TGA) measurements were also made on the batch materials. The analyses were performed in air using heating rates of 1° C./min to 800° C., followed by 4° C./min to 1400° C., in order to investigate the temperature range for Zr oxidation in the RBZM bodies during firing. A typical TGA result for RBZM-2 is shown in FIG. 1. The low temperature (<300° C.) weight losses are the result of binder/water/ethanol evaporation and burn-off. Between 300° C. and 460° C., the TGA trace shows a 2.4% weight gain as a result of Zr oxidation, after which the weight remained constant. The relatively low temperature range of 300-460° C. for Zr oxidation is a consequence of the high (˜30 atom %) solubility of oxygen in Zr, which delays or prevents formation of a protective oxide film by allowing O ions to diffuse into the underlying Zr(O).

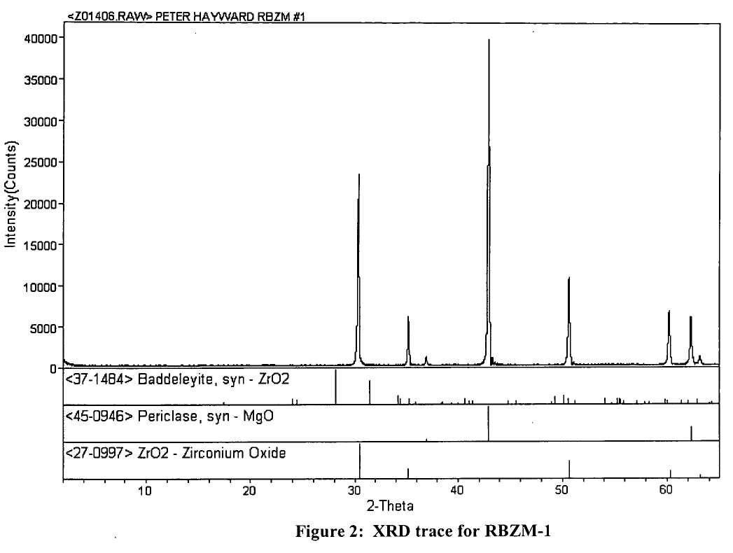

X-ray diffraction (XRD) analyses were performed on the fired RBZM pellets, scanning in the range 5-65° 2θ using Cu K_{α1} radiation. A typical XRD trace for RBZM-1 is shown in FIG. 2. No XRD peaks corresponding to unstabilized monoclinic ZrO₂ (baddelyite) were observed in any of the traces. Thus, the analyses confirm that the ZrO₂ formed by Zr oxidation had completely reacted with the coarse MgO powder during firing to form MgO-stabilized ZrO₂.

Shrinkage. Porosity Permeability and (Cold) Modulus of Rupture Measurements: The properties of each series of 8 pellets were measured using standard techniques, with the results (±2 standard deviations) shown in Table 5.

The results for RBZM 1-3 confirm that adjustment of the initial Zr-metal content in each mix is an effective way of controlling the final firing shrinkage, giving in each case a fired body with high porosity and gas permeability. There is, however, a reduction in strength at higher Zr contents, so that the optimum combination of properties is given by a composition with a relatively low firing shrinkage, such as RBZM-1 or RBZM-2.

TABLE 5
Shrinkage, Porosity, Air Permeability (D) and
Modulus of Rupture of RBZM Pellets

| | | | Permeability | Modulus of |
|---|---|---|---|---|
| | | | 10³ D | Rupture |
| RBZM | Shrinkage % | Porosity % | (m²/bar · s) | (Mpa) |
| 1 | 2.8 ± 0.3 | 40.1 ± 2.6 | 6.57 ± 0.43 | 5.22 ± 0.85 |
| 2 | 1.1 ± 0.3 | 39.8 ± 3.2 | 4.82 ± 0.39 | 4.71 ± 1.25 |
| 3 | −1.6 ± 0.7 | 44.0 ± 4.6 | 6.34 ± 0.94 | 2.86 ± 0.66 |

### EXAMPLE 2

Pressed pellets of zirconium, zirconia, and magnesia grains, together with sintering aids, were fired to produce zirconia-bonded magnesia pellets (RBZM), which were characterized by different means. Table 6 shows the batch compositions of two formulations examined, based on the RBZM-1 composition in Example 1, but with 1.0 wt. % (inorganic solid basis) addition of fumed TiO₂ or CeO₂ to promote sintering and increase pellet strength. The RBZM-1 composition is also included for comparison.

The dopant additions were made as follows.

RBZM-11: 0.8 g NanoTek titania was dispersed in 25 mL water containing 0.2 g Darvan C (dispersing agent) using a magnetic stirrer. While still stirring, the remaining inorganic components were added and stirred to form a sloppy paste, which was then dried overnight at 100° C. The dried powders were briefly dry-milled with alumina media to break up agglomerates. After removal of the media and blending in of the methylcellulose powder, the solids were thoroughly mixed with a solution of stearic acid in warm ethanol. Finally, a mixed solution of the ethylene glycol, PVA solution and pure water components was added and blended in. The batch was then sealed in polyethylene and stored overnight for hydration of the methylcellulose powder.

TABLE 6
Batch Compositions for Used for Firing Trials

| Component | RBZM-1 | RBZM-11 | RBZM-12 |
|---|---|---|---|
| Coarse magnesia (Cerac | 47.3 g | 47.3 g | 47.3 g |
| M-1138, 95% pure, −140 | | | |
| mesh +325 mesh) | | | |
| Yttria-stabilized ZrO₂ | 22.3 g | 22.3 g | 22.3 g |
| (Magnesium Elektron Inc., | | | |
| type 5Y, 0.6 μm, 8% Y₂O₃) | | | |
| Zr metal powder | 8.0 g | 8.0 g | 8.0 g |
| (Alfa Aesar, stock # | | | |
| 00847, 95+% purity, 2-3 μm) | | | |
| Nano Tek titania (25-51 nm) | — | 0.8 g | — |
| *CeO₂ | — | — | 0.8 g |
| Tylose MH300 methyl | 4.2 g | 4.2 g | 4.2 g |
| cellulose | | | |
| Elvanol grade 85-82 PVA, | 1.1 g | 1.1 g | 1.1 g |
| 7 wt. % solution in water | | | |
| Stearic acid | 1.1 g | 1.1 g | 1.1 g |
| Ethylene glycol | 0.4 g | 0.4 g | 0.4 g |
| Ethanol (denatured alcohol) | 4.0 g | 4.0 g | 4.0 g |
| Water | 10.0 g | 10.0 g | 10.0 g |
| Description | Reference | RBZM-1 + | RBZM-1 + |
| | composition | 1% TiO₂ | 1% CeO₂ |

*Added in solution as 2.55 g (NH₄)₂Ce(NO₃)₆, AR grade

RBZM-12: The magnesia, zirconia and Zr-metal powders were briefly milled with dry alumina media to break up agglomerates. After blending in the methylcellulose powder, the solids were thoroughly mixed with a solution of stearic acid in warm ethanol. Finally, a mixed solution of the ceric ammonium nitrate, ethylene glycol, PVA solution and pure water components was added and blended in. The batch was sealed in polyethylene and stored overnight for methylcellulose hydration.

Six pellets of each batch composition were pressed and dried as in Example 1. Pellet firing was performed using the same combination of furnaces as in Example 1, with the following firing schedules:
Carbolite furnace: heated at 1° C./min to 500° C., 2° C./min to 1400° C., followed by immediate cooling at 10° C./min. The pellets were then transferred to the CM furnace.
CM furnace: heated at 10° C./min to 1500° C., holding for 2 hours at 1500±10° C. before cooling at 10° C./min to room temperature.

Shrinkage, Porosity, Permeability and (Cold) Modulus of Rupture Measurements: The properties of each pellet series were measured using the same techniques as in Example 1, with the results (±2 standard deviations) shown in Table 7:

Comparison of the results for RZBM-1 and RBZM-11 shows that TiO₂ doping gave a ˜60% increase in strength. The mean pellet shrinkage increased to from 1.7% to 3%, and the permeability and porosity were slightly reduced. Thus, TiO₂ undoubtedly acts as a sintering aid in this system, possibly by forming traces of a magnesium titanate compound (e.g., Mg₂TiO₄) and/or ZrTiO₄ solid solution.

The results for CeO₂-doped RBZM 12 show a slight increase in strength and in shrinkage, as compared to RBZM 1, but with no significant effects on permeability and porosity. The only known Ce reaction in this system is formation of Ce-stabilized ZrO₂ (analogous to MgO-stabilized ZrO₂ formation in undoped RBZM-1). Thus, CeO₂ is a less effective sintering aid for this system.

TABLE 7
Shrinkage, Porosity, Air Permeability (D) and Modulus of Rupture Data

| | | | Permeability | Modulus of |
|---|---|---|---|---|
| | | | 10³ D | Rupture |
| RBZM | Shrinkage % | Porosity % | (m²/bar · s) | (Mpa) |
| 1 | 1.7 ± 0.3 | 38.9 ± 1.0 | 5.46 ± 2.87 | 3.54 ± 1.20 |
| 11 | 3.0 ± 0.3 | 36.1 ± 1.3 | 3.72 ± 0.50 | 5.69 ± 0.50 |
| 12 | 3.8 ± 0.3 | 41.3 ± 1.4 | 5.81 ± 2.08 | 3.88 ± 0.83 |

Other likely sintering aids for RBZM compositions include minor (<1 wt. %) additions of salt that at temperatures just below the sintering temperature (˜1500° C. in these examples), thereby forming a liquid phase that will accelerate mass transfer between contacting grains and encourage formation of sintering “necks”. Examples of such salts include LiF (m.pt. 870° C., b.pt. 1676,° C.), and MgF₂ (m.pt. 1266° C., b.pt. >2200° C.).

### EXAMPLE 3

Pressed pellets containing a mixture of coarse and fine magnesia, together with silicon metal powder were fired in air to produce forsterite-bonded magnesia pellets. Table 8 shows the batch compositions of four such formulations (designated MS).

Composition MS-6 contained stoichiometric amounts of fine MgO and Si metal required for formation of pure forsterite (Mg₂SiO₄) after Si oxidation and reaction bonding. The target volume ratio of phases in the fired pellets was 70% coarse MgO, 30% forsterite.

Composition MS-7 was derived by increasing the Si content in MS-6 by 25%. This increase was made to investigate whether any significant property changes were produced from reaction of the additional oxidized Si with the coarse MgO component. In this case, the target volume ratio of phases in the fired pellets was ˜64% coarse MgO, ˜36% forsterite.

TABLE 8
Wt. % Batch Compositions of MS Formulations

| Component | MS-6 | MS-7 | MS-8 | MS-9 |
|---|---|---|---|---|
| Coarse magnesia (Cerac M-1138, | 61.59 | 61.59 | 61.59 | 61.59 |
| 95% pure, −140 mesh +325 mesh) | | | | |
| Fine magnesia (Cerac M-1016, | 13.57 | 13.57 | 13.57 | 13.57 |
| 99.5% pure, −325 mesh, Fisher size | | | | |
| 0.25 μm) | | | | |
| Si metal, 1-5 μm (AEE SI-100) | 4.73 | 5.91 | 4.73 | 4.73 |
| Degussa P25 fumed TiO₂ | 0.0 | 0.0 | 0.8 | 0.0 |
| *Fisher A.R. grade MgCl₂.6H₂O | 0.0 | 0.0 | 0.0 | 0.9 |
| Ethanol | 4.8 | 4.8 | 4.8 | 4.8 |
| Stearic acid | 1.6 | 1.6 | 1.6 | 1.6 |
| Isopropyl alcohol (IPA) | 6.8 | 6.8 | 6.8 | 6.8 |
| Elvanol grade 85-82 PVA, 5 wt. % | 6.8 | 6.8 | 6.8 | 6.8 |
| solution in hot ethylene glycol | | | | |

*Added after previous dehydration (see below)

Compositions MS-8 and MS-9 were based on that of MS-6, but with the addition of potential sintering aids. Thus, as a fraction of the inorganic solids in each mix, MS-8 and MS-9 contained, respectively, 1 wt. % of fumed TiO₂ and 0.5 wt. % MgCl₂.

Mixing and Pressing Procedures: Compositions MS-6, -7, and -8 were prepared by briefly dry-milling the inorganic solids (coarse and fine MgO, Si powder; also fumed TiO₂ in MS-8) with alumina media to break up agglomerates. The stearic acid was dissolved in a warmed (˜50° C.) mixture of ethanol+IPA, added to the powder and thoroughly mixed. Finally, the hot PVA/ethylene glycol solution was added to the mix and blended in.

For composition MS-9, the 0.5 wt. % MgCl₂ addition was made by dissolving the appropriate amount of MgCl₂.6H₂O in ethanol and evaporating to dryness on a hotplate. The dried residue, plus stearic acid, was then dissolved in warmed ethanol/IPA and blended into the milled powders, followed by addition and blending in of the hot PVA/ethylene glycol solution.

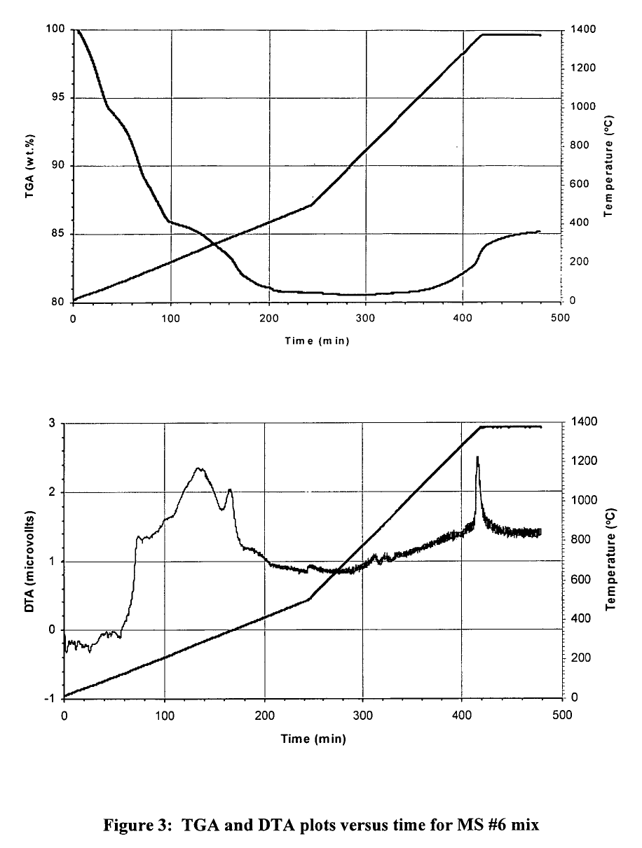

A series of ˜4-g pellets of each batch composition was pressed and dried as in Examples 1 and 2. The pellet-firing schedule was determined from the results of DTA/TGA analysis on the MS-6 batch material. The DTA/TGA analysis was performed using heating rates in air of 2° C./min to 500° C., and 50C/min from 500 to 1375° C., followed by holding at 1375° C. (i.e., below the 1410° C. Si melting temperature) for 1 hour to determine the time taken for complete Si oxidation and reaction to occur. The DTA/TGA results are shown in FIG. 3. The data in FIG. 3 indicate initial weight losses from solvent loss and binder burn-off up to ˜600° C. The sample weight then remained fairly constant until slow Si oxidation commenced at ˜1000° C. There was a notable increase in weight-gain rate at ˜1350° C., accompanied by a DTA exothermic peak (onset at ˜1366° C.) that is attributed to reaction to produce forsterite. The TGA trace leveled off after 1 h at 1375° C., indicating that Si oxidation was essentially complete.

Based on the DTA/TGA results, two schedules were employed for pellet firing, each employing a combination of the Carbolite and CM furnaces, as in Examples 1 and 2. The first schedule, referred to as Schedule 1, was used with 10 pellets of MS-6, fired flat on refractory alumina-fiber batts, and was designed to allow periodic pellet-diameter measurements to be made during firing, as follows:

Schedule 1:
Carbolite furnace: fired to 500° C. at 2° C./min, and then from 500 to 1375° C. at 5° C./min, holding for 2 h at 1375° C. before cooling to room temperature at 10° C./min. Pellet diameters were measured at this stage.
CM furnace: A 10° C./min heating rate was used for all firings, with pellet diameters being measured after each stage. The pellets were initially fired to 1500° C., held for 5 min, and then cooled. The pellets were re-heated to 1500° C., held for 1 h, and cooled. They were then re-heated to 1500° C. for a further 1 h before cooling. Finally 5 pellets (one half) from each 10-pellet set were re-heated to 1500° C., held for 2 h before final cooling.

The second schedule, referred to as Schedule 2, was based on lessons learned from the experience with Schedule 1, and involved pellet firing using alumina-fiber refractory supports in which a series of grooves had been ground to allow the pellets to be stacked vertically, i.e., on their edges. This schedule was used for firing eight pellets each of MS-6, MS-7, MS-8 and MS-9.

Schedule 2:
Carbolite furnace: fired to 500° C. at 2° C./min, from 500 to 1000° C. at 5° C./min, and then from 1000 to 1375° C. at 2° C./min, holding for 2 h at 1375° C. before cooling to room temperature at 10° C./min. Pellet diameters were measured at this stage.
CM furnace: fired to 1500° C. at 10° C./min, and held for 4 h at 1500±10° C. before cooling to room temperature at 10° C./min.

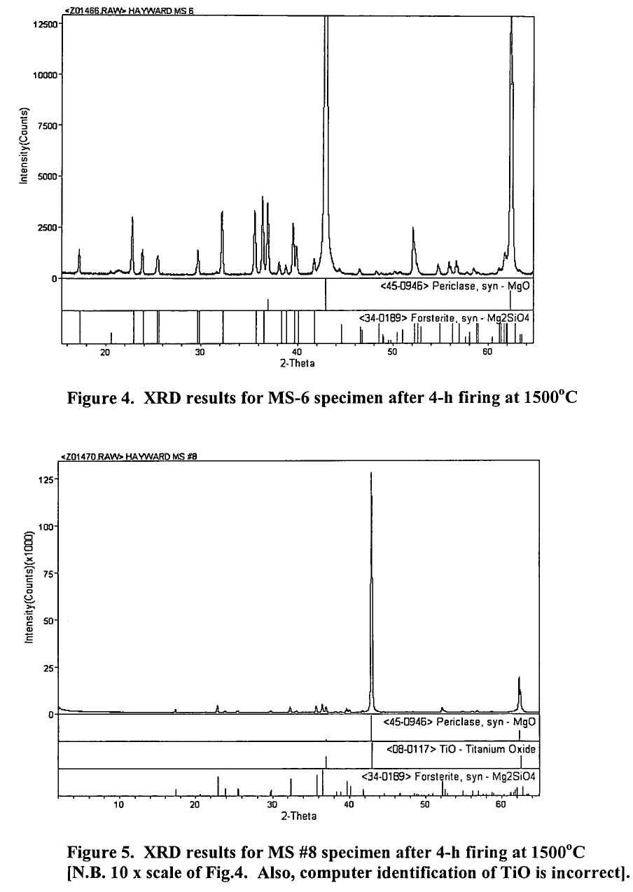

XRD analyses of fired pellets: XRD analyses were made on crushed samples of MS-6 after Schedule-1 firing, and of MS-8 (TiO₂-doped composition) after Schedule-2 firing, in order to confirm that all silica from Si oxidation had reacted with MgO to form forsterite. It was particularly important to establish that there was no unreacted cristobalite or other SiO₂ polymorph remaining in the final phase assemblage. The XRD traces, shown for MS-6 and MS-8 in FIGS. 4 and 5, respectively, were virtually identical, and confirmed that the only phases present were MgO (periclase) and Mg₂SiO₄ (forsterite), i.e., that all silica had reacted to form forsterite.

Shrinkage Measurements: The progressive shrinkages shown by the pellet samples are summarized in Table 9.

TABLE 9
Progressive Shrinkage Measurements (Mean ± 2SD) during Firing

| Composition: MS-6 | Schedule 1 firing | | | | |
|---|---|---|---|---|---|
| Temperature/time | 1375° C./2-h | 1500° C./0-h | 1500° C./1-h | 1500° C./2-h | 1500° C./4-h |
| No. of pellets | 10 | 10 | 10 | 10 | 5 |
| Shrinkage (%) | 1.8 ± 0.2 | 1.9 ± 0.2 | 1.9 ± 0.2 | 2.0 ± 0.2 | 2.1 ± 0.1 |

| | Schedule 2 | | |
|---|---|---|---|
| Firing Schedule | No. of | % Shrinkage after | % Shrinkage |
| Composition | pellets | 1375° C./2-h | after 1500° C./4-h |
| MS-6 | 8 | 1.7 ± 0.1 | 2.1 ± 0.1 |
| MS-7 | 8 | 2.0 ± 0.2 | 2.1 ± 0.1 |
| MS-8 | 8 | 1.9 ± 0.3 | 4.5 ± 0.2 |
| MS-9 | 8 | 1.7 ± 0.1 | 1.8 ± 0.1 |

The shrinkage measurements for MS-6 (schedule 1 firing) and for MS-6, MS-7 and MS-9 (schedule 2 firing) indicate that most shrinkage occurred during the binder burn-off stage, i.e., below the Si oxidation temperature. There would be some expansion as a result of Si oxidation/reaction, particularly during the 2-h hold at 1375° C. Nevertheless, the amount of shrinkage from subsequent 1500° C. sintering was relatively small.

The MS-8 (TiO₂-doped) pellets during schedule 2 firing also gave comparable shrinkages after a 2-h hold at 1375° C. This composition, however, gave further shrinkage during subsequent 1500° C./4-h sintering, which undoubtedly correlates with the strength enhancement (see below) caused by use of a sintering aid.

Shrinkage, Porosity, Permeability and (Cold) Modulus of Rupture Measurements:

The properties of each pellet series were measured using standard techniques, with the results (±2 standard deviations) shown in Table 10. The two sets of results for MS-6 are identical, within statistical limits, implying that the change in firing schedule, and in the vertical or horizontal orientation of pellets during firing, had no significant influence on pellet properties.

TABLE 10
Shrinkage, Porosity, Air Permeability (D) and Modulus of Rupture of MS Pellets

| | | | | Permeability | Flexural |
|---|---|---|---|---|---|
| | Firing | | | 10³ D | Strength |
| Pellet Series | Schedule | Shrinkage % | Porosity % | (m²/bar · s) | (MPa) |
| MS-6, 1500° C./4 h | 1 | 2.1 ± 0.1 | 32.2 ± 0.9 | 4.28 ± 0.94 | 7.76 ± 1.31 |
| MS-6, 1500° C./4 h | 2 | 2.1 ± 0.1 | 32.4 ± 0.8 | 3.41 ± 0.35 | 7.31 ± 0.92 |
| MS-7, 1500° C./4 h | 2 | 2.1 ± 0.2 | 28.8 ± 1.1 | 3.38 ± 0.39 | 7.27 ± 0.83 |
| MS-8, 1500° C./4 h | 2 | 4.5 ± 0.2 | 27.5 ± 1.7 | 5.03 ± 0.89 | 15.10 ± 1.82 |
| MS-9, 1500° C./4 h | 2 | 1.8 ± 0.1 | 32.5 ± 1.0 | 3.40 ± 0.72 | 8.14 ± 1.06 |

Similarly, the increase in Si content, and hence in anticipated forsterite content, in going from the MS-6 to MS-7 composition did not produce any significant change in properties, apart from a slight decrease in porosity. In particular, the strength was not improved, implying that only the forsterite produced from Si oxidation and reaction with fine MgO is effective in bonding the coarse grains together.

The effects of TiO₂ doping were quite dramatic. Thus, in comparison with the baseline MS-6 composition, the mean strength was increased by a factor of ˜2. The mean permeability was increased by ˜50%, whereas the mean porosity was slightly decreased. However, the mean firing shrinkage also increased from 2.1% to 4.5%. Nevertheless, these results imply that TiO₂-doped MS compositions would be excellent materials for production of extruded monoliths to serve as ion-transport-membrane substrates, provided that the monolith could withstand a 4.5% uniform shrinkage during firing. If this amount of firing shrinkage were to prove problematic, however, a reduced level of TiO₂ doping would still be beneficial to overall properties.

The effects of MgCl₂ doping were minimal. Thus, in comparison with the baseline MS-6 composition, there were no notable changes in porosity and permeability, a slight reduction in firing shrinkage, and only a ˜10% enhancement is strength that is probably statistically insignificant. Hence, although MgCl₂ is a known sintering aid for MgO ceramics, it probably has little influence on Si oxidation and forsterite formation—the main factor in developing strong bonds between coarse MgO grains in MS compositions.

### EXAMPLE 4

Pressed pellets containing a mixture of coarse and fine magnesia powders, together with aluminum metal powder, were fired in air to produce spinel-bonded magnesia pellets. Table 11 shows the batch compositions of two such formulations, designated MA. In both cases, the pellet compositions contained stoichiometric amounts of fine MgO and Al metal required for formation of pure spinel (MgAl₂O₄) after Al oxidation and reaction bonding. The target volume ratio of phases in the fired pellets was ˜60 vol. % coarse MgO (CTE ˜13.5×10⁻⁶° C.⁻¹), with the balance being spinel (CTE ˜8.5×10⁻⁶° C.⁻¹).

Mixing and Pressing Procedures: Compositions MA-1 and MA-2 were prepared by briefly dry-milling the inorganic solids (coarse and fine MgO, Al powder) with alumina media to break up agglomerates. The stearic acid was dissolved in a warmed (˜50° C.) mixture of ethanol+IPA, added to the powder and thoroughly mixed. Finally, the hot PVA/ethylene glycol solution was added to the mix and blended in.

TABLE 11
Wt. % Batch Compositions of MA Formulations

| Component | MA-1 | MA-2 |
|---|---|---|
| Coarse magnesia (Cerac M-1138, | 62.3 | 55.4 |
| 95% pure, −140 mesh +325 mesh) | | |
| Fine magnesia (Cerac M-1016, | 7.6 | 10.5 |
| 99.5% pure, −325 mesh, Fisher size | | |
| 0.25 μm) | | |
| Al metal, 1-5 μm (AEE AL-104) | 10.2 | 14.1 |
| Ethanol | 4.8 | 4.8 |
| Stearic acid | 1.6 | 1.6 |
| Isopropyl alcohol (IPA) | 5.6 | 5.6 |
| Elvanol grade 85-82 PVA, 5 wt. % | 8.0 | 8.0 |
| solution in hot ethylene glycol | | |

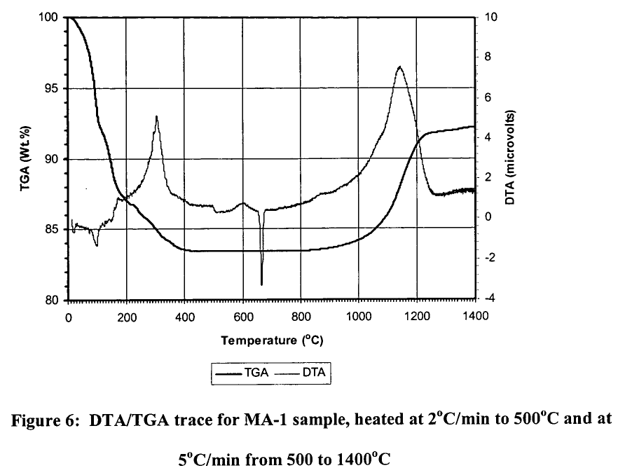

A series of ˜4-g pellets of each batch composition was pressed and dried as in Examples 1-3. The pellet-firing schedule was determined from the results of DTA/TGA analysis on the MA-1 batch material, using heating rates in air of 2° C./min to 500° C., followed by 5° C./min from 500 to 1400° C. The DTA/TGA results are shown in FIG. 6.

The data in FIG. 6 indicate initial weight losses from solvent loss and binder burn-off up to ˜450° C. The DTA trace shows a sharp endothermic peak at ˜660° C. produced by Al-metal melting. Oxidation of the molten metal commenced at ˜850° C. and was still in progress at 1400° C. However, most of the oxidation occurred within the range 1000-1200° C., with a maximum oxidation rate indicated by the corresponding DTA peak at ˜1150° C. The amount of unoxidized Al at the end of the run, calculated from the starting composition and the weight gain from 850° C. to 1400° C., was ˜6.7%.

Based on the DTA/TGA results, the following schedule was employed for pellet firing, using a combination of the Carbolite and CM furnaces, as in Examples 1-3:
Carbolite furnace: fired to 500° C. at 2° C./min, and then from 500 to 1400° C. at 5° C./min, holding for 1 h at 1400° C. before cooling to room temperature at 101° C./min. Pellet diameters were measured at this stage.
CM furnace: fired to 1500° C. at 10° C./min, holding for 4 h at 1500±10° C. before cooling to room temperature at 10° C./min.

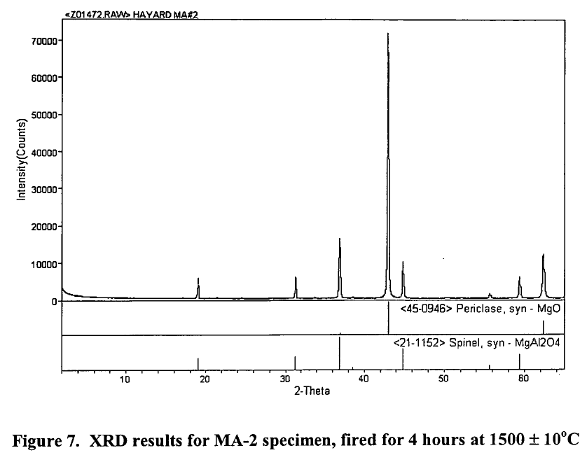

XRD analysis of fired MA-2 pellet: An XRD analysis was made on a crushed sample of fired MA-2 pellet. The analysis results, shown in FIG. 7, confirm that the only phases present were MgO and spinel. Thus, complete Al oxidation and reaction with fine MgO had occurred during firing to form spinel.

Shrinkage Measurements: The progressive shrinkages shown by the pellet samples after 1st fire (Carbolite furnace) and 2^{nd} fire (CM furnace) are summarized in Table 12. With both compositions, the pellets expanded, giving a negative shrinkage value, during 1^{st} fire as a result of Al-metal oxidation. Subsequent shrinkage during high temperature sintering at 1500° C. produced a final shrinkage of ˜1.5%.

Shrinkage, Porosity Permeability and (Cold) Modulus of Rupture Measurements: The properties of each pellet series were measured using standard techniques, with the results (±2 standard deviations) shown in Table 13. The results for each pellet series are identical, within statistical limits, i.e., there is overlap in the ±2SD error bands for each property. These results are comparable with the best results obtained for reaction-bonded forsterite-magnesia substrate materials (see Example 3, Table 10).

TABLE 12
Progressive Shrinkage Measurements (Mean ± 2SD) during Firing

| | No. of | % Shrinkage after | % Shrinkage |
|---|---|---|---|
| Composition | pellets | 1400° C./1 h | after 1500° C./4 h |
| MA-1 | 8 | −0.5 ± 0.2 | 1.4 ± 0.1 |
| MA-2 | 8 | −0.3 ± 0.1 | 1.5 ± 0.3 |

TABLE 13
Property data ± 2SD for MA pellets.

| | Target | | | | |
|---|---|---|---|---|---|
| | vol. % | | | Permeability | Flexural |
| Pellet | MgO/ | Shrinkage | | 10³ D | Strength |
| Series | spinel | % | Porosity % | (m²/bar · s) | (MPa) |
| MA-1 | 70/30 | 1.4 ± 0.1 | 32.5 ± 3.0 | 3.13 ± 0.73 | 8.94 ± 2.28 |
| MA-2 | 60/40 | 1.5 ± 0.3 | 31.4 ± 1.2 | 2.47 ± 0.27 | 11.71 ± 1.48 |

Although specific features of the invention are described in various embodiments, this is for convenience only as each feature may be combined with any or all of the other features in accordance with the invention. Other embodiments will occur to those skilled in the art and are within the scope of the following claims:

1. A porous reaction-bonded magnesia body.

2. The body of claim 1 which has a porosity greater than about 30%.

3. The body of claim 1 which has a mean pore size greater than about 1 micron.

4. A membrane device comprising the body of claim 1 as a support for a permselective membrane.

5. The device of claim 4 in which the membrane device is suitable for gas separations

6. The device of claim 5 in which the permselective membrane is selected from the group comprising dense metallic and ion transport membranes.

7. The body of claim 1 in which the structure of the body is selected from the group of configurations containing tubular, planar, hollow fiber, and multiple passageway monolith configurations.

8. A porous reaction-bonded magnesia body formed by sintering a green body containing coarse magnesia grains and reactive grains of an inorganic binder precursor.

9. The body of claim 8 for which a reaction bond is formed from the reaction of grains of an element admixed with the coarse magnesia grains.

10. The body of claim 8 in which the magnesia grains have a mean particle size in the range of about 5 to 200 microns.

11. The body of claim 9 in which the element is selected from the group comprising aluminum, silicon, titanium, zirconium, and mixtures thereof.

12. The body of claim 8 in which the green body contains silicon grains and the reaction bond is forsterite.

13. The body of claim 8 in which the green body contains aluminum grains and the reaction bond is spinel.

14. The body of claim 8 that has a volume change from the unsintered green body of less than about five percent.

15. A method for making a porous reaction-bonded magnesia body, comprising:
Making a mixture containing at least coarse magnesia grains and grains of an inorganic reactive binder precursor;
Forming the mixture into a desired shape and drying to obtain a green body;
Firing the green body to a temperature sufficient to react the reactive inorganic binder precursor; and
Cooling the reaction-bonded body.
